(19) United States
(12) Patent Application Publication
(10) Pub. No.: US 2015/0237903 A1
(43) Pub. Date: Aug. 27, 2015

(54) HIGH PROTEIN, LOW VISCOSITY LIQUID NUTRITIONAL PRODUCT WITH HMB

(71) Applicant: ABBOT LABORATORIES, Abbott Park, IL (US)

(72) Inventors: Gaurav Patel, Gahanna, OH (US); Romel Somavat, Columbus, OH (US); Normanella Dewille, Columbus, OH (US)

(73) Assignee: ABBOTT LABORATORIES, Abbott Park, IL (US)

(21) Appl. No.: 14/437,855

(22) PCT Filed: Oct. 24, 2013
(86) PCT No.: PCT/US2013/066672

§ 371 Date: Apr. 23, 2015

Related U.S. Application Data
(60) Provisional application No. 61/717,768, filed on Oct. 24, 2012.

(51) Int. Cl. A23L 1/305; A23L 1/236; A23L 1/304; A23J 3/10

(52) U.S. Cl. CPC A23L 1/3056; A23J 3/10; A23L 1/236; A23L 1/304

(57) ABSTRACT

Nutritional products with improved organoleptic properties are provided herein. The general inventive concepts provide liquid nutritional products with improved viscosities while providing relatively higher levels of protein. In certain exemplary embodiments, the liquid nutritional products further provide beta-hydroxy-beta-methylbutyrate in addition to relatively higher levels of protein while maintaining a pleasant mouthfeel when consumed.

### CROSS-REFERENCE TO RELATED APPLICATION

This application claims priority to and any other benefit of U.S. application Ser. No. 61/717,768, filed Oct. 24, 2012, the entire disclosure of which is incorporated by reference herein.

### BACKGROUND

The viscosity of a liquid nutritional product can affect the mouthfeel of the product and impact ease of consumption by consumers with lower viscosity liquids generally having better mouthfeel and being easier to consume. In certain applications, it can be beneficial for a liquid nutritional product to have high protein content. However, the addition of large amounts of protein is generally associated with an increase in product thickness or viscosity making the products somewhat or significantly more difficult and less pleasant to consume. The addition of other ingredients such as HMB and calcium also tends to result in a higher viscosity product.

### SUMMARY

Provided herein are high protein, low viscosity liquid nutritional products. By utilizing a specified blend of protein sources, a viscosity at 25° C. of 25-75 cps (25-75 millipoise·sec) can be obtained in a product that contains a total of 80-110 grams per liter protein and at least 4 grams per liter beta-hydroxy-beta-methylbutyrate.

The high protein low viscosity liquid nutritional product provided herein contains water, at least one source of beta-hydroxy-beta-methylbutyrate in an amount sufficient to provide at least 4 g/L beta-hydroxy-beta-methylbutyrate; a total of 80-110 grams per liter of protein; and at least one source of carbohydrate and has a viscosity at 25° C. of 25-75 cps (25-75 mPa·seconds). The protein is comprised of at least 30-70 weight % sodium caseinate, at least 30 weight % milk protein isolate, up to 20 weight % soy protein and up to 10 weight % whey protein (with the weight percentages being calculated using the weight of protein provided by a particular source in relation to the total weight of protein present in the liquid nutritional product).

Also provided herein is a high protein, low viscosity liquid nutritional product comprising water; at least one source of beta-hydroxy-beta-methylbutyrate in an amount sufficient to provide at least 4 g/L beta-hydroxy-beta-methylbutyrate; a total of 80-110 grams per liter of protein; at least one source of carbohydrate; at least one source of fat; and at least one source of calcium in an amount sufficient to provide at least 500 mg/L calcium. This liquid nutritional product has a viscosity at 25° C. of 30-75 cps (30-75 mPa·seconds). Within the liquid nutritional product, the protein comprises 30-55 weight % sodium caseinate, at least 35 weight % milk protein isolate, 5-20 weight % soy protein isolate, and 5-10 weight % whey protein.

Additionally provided is a liquid nutritional product comprising water, at least one source of beta-hydroxy-beta-methylbutyrate in an amount sufficient to provide at least 4 g/L beta-hydroxy-beta-methylbutyrate, a total of 80-110 grams per liter of protein, at least one source of carbohydrate, and at least one source of calcium in an amount sufficient to provide at least 500 mg/L calcium. The at least one source of beta-hydroxy-beta-methylbutyrate is selected from the group consisting of sodium HMB, potassium HMB, magnesium HMB, chromium HMB, calcium HMB, alkali metal HMB, alkaline earth metal HMB, HMB lactone and combinations thereof. Furthermore, the liquid nutritional product has a viscosity at 25° C. of 30-75 cps (30-75 mPa·seconds). The 85-100 grams per liter of protein is comprised of 30-60 weight % sodium caseinate, at least 35 weight % milk protein isolate and, at least 5 weight % soy protein isolate, whey protein or a combination thereof.

### DETAILED DESCRIPTION

The liquid nutritional products disclosed herein are high in protein and low in viscosity, utilizing a specified blend of protein sources, and have a viscosity at 25° C. of 25-75 cps (25-75 mPa·seconds) along with a total of 80-110 grams per liter of protein and at least 4 grams per liter beta-hydroxy-beta-methylbutyrate.

The high protein low viscosity liquid nutritional product provided herein contains water, at least one source of beta-hydroxy-beta-methylbutyrate in an amount sufficient to provide at least 4 g/L beta-hydroxy-beta-methylbutyrate; a total of 80-110 grams per liter of protein; and at least one source of carbohydrate and has a viscosity at 25° C. of 25-75 cps (25-75 mPa·seconds). The protein is comprised of at least 30-70 weight % sodium caseinate, at least 30 weight % milk protein isolate, up to 20 weight % soy protein and up to 10 weight % whey protein (with the weight percentages being calculated using the weight of protein provided by a particular source in relation to the total weight of protein present in the liquid nutritional product).

Also provided herein is a high protein, low viscosity liquid nutritional product comprising water; at least one source of beta-hydroxy-beta-methylbutyrate in an amount sufficient to provide at least 4 g/L beta-hydroxy-beta-methylbutyrate; a total of 80-110 grams per liter of protein; at least one source of carbohydrate; at least one source of fat; and at least one source of calcium in an amount sufficient to provide at least 500 mg/L calcium. This liquid nutritional product has a viscosity at 25° C. of 30-75 cps (30-75 mPa·seconds). Within the liquid nutritional product, the protein comprises 30-55 weight % sodium caseinate, at least 35 weight % milk protein isolate, 5-20 weight % soy protein isolate, and 5-10 weight % whey protein.

Additionally provided is a liquid nutritional product comprising water, at least one source of beta-hydroxy-beta-methylbutyrate in an amount sufficient to provide at least 4 g/L beta-hydroxy-beta-methylbutyrate, a total of 80-110 grams per liter of protein, at least one source of carbohydrate, and at least one source of calcium in an amount sufficient to provide at least 500 mg/L calcium. The at least one source of beta-hydroxy-beta-methylbutyrate is selected from the group consisting of sodium HMB, potassium HMB, magnesium HMB, chromium HMB, calcium HMB, alkali metal HMB, alkaline earth metal HMB, HMB lactone and combinations thereof. Furthermore, the liquid nutritional product has a viscosity at 25° C. of 30-75 cps (30-75 mPa·seconds). The 80-100 grams per liter of protein is comprised of 30-60 weight % sodium caseinate, at least 35 weight % milk protein isolate and, at least 5 weight % soy protein isolate, whey protein or a combination thereof.

As previously described, in the liquid nutritional products disclosed herein, the 80-110 grams per liter of total protein is provided by a combination of proteins. In certain embodiments, the liquid nutritional products disclosed herein contain 85-110 grams per liter of total provided, provided by a combination of proteins. In one embodiment, 30-70 weight % of the total protein is sodium caseinate, at least 30 weight % of the total protein is milk protein isolate, up to 20 weight % of the total protein is soy protein and up to 10 weight % of the total protein is whey (with the percentages based upon the total weight of protein present in the liquid nutritional product). By stating that the soy protein comprises up to 20 weight % of the total protein, it is intended that the soy protein present is present in an amount of 0-20 weight % of the total protein. By stating that the milk protein isolate comprises at least 30 weight % of the total protein, it is intended that the amount of milk protein isolate may range from 30-70 weight % of the total protein. By stating that whey protein comprises up to 10 weight % of the total protein, it is intended that the whey protein is present in an amount of 0-10 weight % of the total protein. In certain embodiments of the liquid nutritional compositions disclosed herein, sodium caseinate comprises 30-60 weight % of the total protein; milk protein isolate comprises at least 35 weight % of the total protein; whey protein, soy protein, or a combination thereof comprises at least 5 weight % of the total protein. In other embodiments, the protein comprises 5-20 weight % soy protein and 5-10 weight % whey, 30-55 weight % sodium caseinate, and at least 35 weight % milk protein isolate.

As previously discussed, the amount of sodium caseinate that is present in the liquid nutritional products disclosed herein is 30-70 weight % of the total protein in some embodiments, 30-60 weight % of the protein in some embodiments, and 30-55 weight % of the total protein in other embodiments. The sodium caseinate may be provided by one or more than one source. Various commercial sources of sodium caseinate exist. Preferably, the source(s) of sodium caseinate is a low viscosity sodium caseinate such as Sodium Caseinate 166 (available from Fonterra Co-operative Group Limited, Auckland, New Zealand). Preferably, the protein provided by the source(s) of sodium caseinate is intact protein.

In certain embodiments of the above-described liquid nutritional products, calcium caseinate can comprise a portion of the protein. When calcium caseinate is utilized, it preferably comprises no more than 10 weight % of the total protein in order to minimize undesirable taste notes. For liquid nutritional products where taste restrictions are less specific, it may be possible to utilize relatively more calcium caseinate, such as up to 15 weight % of the total protein or even up to 20 weight % of the total protein while still maintaining a viscosity of 25-75 cps (25-75 mPa·seconds).

As previously discussed, the amount of milk protein isolate that is present in the liquid nutritional products described herein is at least 30 weight % of the total protein component. As used herein, the phrase milk protein isolate should be understood to mean a source of milk protein that comprises milk that has been concentrated (i.e., to remove water and fat) and has also had a portion of its lactose content removed. Generally, commercially available milk protein isolates contain about 85-90 weight % protein (or more), about 2-5 weight % lactose, minimal fat (i.e., 1-3%) and about 5-6 weight % water. In certain embodiments of the liquid nutritional products disclosed herein, the amount of milk protein isolate is at least 35 weight % of the total protein. The milk protein isolate may be provided by one or more than one source. Various commercial sources of milk protein isolate exist. Preferably, the source(s) of milk protein isolate contains at least 85 weight % protein (w/w, based on the total weight of the milk protein isolate source), has a lactose content of 5% or less, a water content of less than 6%, a fat content of less than 3% and an ash content of 8% or less (all of the immediately percentages being weight percentages). Various commercial sources of milk protein isolate are available, including, but not limited to Milk Protein Concentrate 4861 from Fonterra Co-operative Group Limited, Auckland, New Zealand). Milk Protein Concentrate 4861 contains a minimum of 85 weight % protein, no more than 6% water, no more than 2.5% fat and no more than 5% lactose. (The term milk protein concentrate is generally used to refer to a milk protein containing product that has had a considerable amount of the inherent water from ordinary milk removed and also has had inherent fat from the ordinary milk removed. The term milk protein isolate is generally used to refer to a type of milk-protein containing product that has not only had a considerable amount of the inherent water from ordinary milk removed and inherent fat but also a certain amount of inherent lactose removed. In most instances, milk protein isolates can be considered to be a type of further purified milk protein concentrate. Certain manufacturers may use the term milk protein concentrate to refer to milk-based protein products even if they contain at least 85 weight % protein and such products should be considered to be within the scope of the term milk protein isolate as that term is used herein.)

When soy protein is utilized in the liquid nutritional products disclosed herein, the soy protein may be provided by one or more than one source. Common forms of soy protein include soy protein concentrates and soy protein isolates. As previously discussed, the amount of soy protein utilized in the liquid nutritional products is up to 20 weight % of the total protein in certain embodiments (i.e., 0-20 weight %) of the total protein, 5-20 weight % of the total protein in other embodiments and can be 15-20 weight % of the total protein in yet other embodiments. Preferably, the soy protein is soy protein concentrate. Commercial sources of soy protein are well known in the nutrition art, some non-limiting examples of which include soy protein isolates distributed by The Solae Company under the trade designation “Soy Protein Isolate EXP-H0118,” “EXP-E-0101, and “Supro Plus 675.”

When whey protein is utilized in the liquid nutritional products disclosed herein, the whey may be provided by one or more than one source. Common forms of whey protein include whey protein concentrate and whey protein isolate. Preferably, the whey protein is present as a whey protein concentrate. Various commercial sources of whey protein exist, containing varying concentrations of protein such as about 75 weight % protein (w/w, based on the total weight of the protein source). As previously discussed, the amount of whey protein utilized in the liquid nutritional products can be up to 10 weight % (i.e., 0-10 weight %) of the total protein in certain embodiments, at least 5 weight % of the total protein in other embodiments and 5-10 weight % of the total protein in yet other embodiments. In certain embodiments, the combined amount of whey protein and soy protein comprises at least 5 weight % (but no more than a maximum of 20 weight % soy protein and 10 weight % whey protein).

In addition to the protein sources discussed above, the liquid nutritional products may also contain protein from one or more other sources, in an amount or amounts that is in accordance with the limitations on the amounts of sodium caseinate, milk protein isolate, soy protein and whey protein, discussed above. The other protein sources will not comprise (in total) more than 40 weight % of the total protein, preferably no more than 30 weight %, no more than 20 weight % or no more than 10 weight %. Suitable and non-limiting examples of additional protein sources include casein from milk, animal products (e.g., meat, fish, egg albumen), cereals (e.g., rice, corn), vegetable (e.g., soy, pea, potato), or combinations thereof. The additional protein sources can also include hydrolyzed proteins from one or more of casein, whey, soy, pea and free amino acids known for use in nutritional products, non-limiting examples of which include lysine, tryptophan, glutamine, tyrosine, L-methionine, cysteine, taurine, L-arginine, carnitine, and combinations thereof.

As previously discussed, the liquid nutritional products contain at least 4 grams per liter beta-hydroxy-beta-methylbutyrate. In certain embodiments of the liquid nutritional products disclosed herein, the amount of HMB is 4-9 grams per liter. The HMB that is present in the liquid nutritional products disclosed herein may be provided by various sources. In certain embodiments, the liquid nutritional product contains one source of HMB. In other embodiments, the liquid nutritional product contains more than one source of HMB, such as two sources, three sources or even more. The HMB molecule exists in a free acid form and also in various modified forms including a salt, an ester and a lactone and the terms HMB and beta-hydroxy-beta-methylbutyrate as used herein are meant to encompass all forms, unless indicated otherwise. Various methods for production of HMB in its various forms are known and commercial sources of HMB exist.

The salt form of HMB currently provides the most preferred form for incorporation into liquid nutritional products. For use in the liquid nutritional products described herein, pharmaceutically acceptable and water-soluble salts are preferred. In certain embodiments of the liquid nutritional products disclosed herein, the beta-hydroxy-beta-methylbutyrate is provided by at least one source selected from the group consisting of sodium HMB, potassium HMB, magnesium HMB, chromium HMB, calcium HMB, alkali metal HMB, alkaline earth metal HMB, HMB lactone and combinations thereof. Preferably, the beta-hydroxy-beta-methylbutyrate is provided by at least one source selected from the group consisting of sodium HMB, potassium HMB, magnesium HMB, chromium HMB, calcium HMB and combinations thereof. Even more preferably, the beta-hydroxy-beta-methylbutyrate is provided by calcium HMB. Calcium HMB is most commonly formulated and available as calcium HMB monohydrate, a commercially available source of which is available from Technical Sourcing International of Salt Lake City, Utah, USA. When one or more salts of HMB are utilized to provide the at least 4 grams per liter HMB or 4-9 grams per liter HMB, the total amount of salt(s) present is sufficient to provide the specified amount of HMB. In other words, the cationic component is not included in the weight specification.

When the source of HMB includes an ester form of HMB, any pharmaceutically acceptable ester can be utilized. Preferably, the HMB ester is converted to HMB in its free acid form. Preferred esters of HMB include, but are not limited to, methyl ester or ethyl ester. HMB methyl ester and HMB ethyl ester are rapidly converted to the free acid form of HMB.

When the source of HMB includes a lactone form of HMB, any pharmaceutically acceptable lactone can be utilized. Preferably, the HMB ester is converted to HMB in its free acid form. Preferred lactones of HMB include, but are not limited to, isovalaryl lactone or a similar lactone. Isovalaryl lactone is rapidly converted to the free acid form of HMB.

As previously discussed, the liquid nutritional products disclosed herein contain at least one source of carbohydrates, preferably more than one source. The particular amount of carbohydrate that is present in the liquid nutritional composition may vary depending upon the nutritional needs of the intended user. Carbohydrate concentrates usually fall within the range of 5 weight % to 40 weight % (percentages are weight percentages based upon the total weight of the liquid nutritional product), 7 weight % to 30 weight %, or 10 weight % to 25 weight %. The amount of carbohydrates present can also be characterized as a percentage of total calories in the liquid nutritional product and may vary widely. In certain embodiments, the at least one source of carbohydrate comprises 10-75% of the total calories of the liquid nutritional composition and in other embodiments 30-50% of the total calories. In certain embodiments, the liquid nutritional product includes at least one source of carbohydrates in an amount sufficient to provide a total of 100-200 grams per liter of carbohydrate.

Various commercial sources of carbohydrates exist and may be utilized in the liquid nutritional products disclosed herein. Non-limiting examples of suitable carbohydrates or sources thereof for use in the liquid nutritional compositions disclosed herein include maltodextrin, hydrolyzed or modified starch or cornstarch, glucose polymers, corn syrup, corn syrup solids, rice-derived carbohydrates, glucose, fructose, lactose, high fructose corn syrup, honey, sugar alcohols (e.g., malitol, erythritol, sorbitol) and combinations thereof.

In certain embodiments of the liquid nutritional products disclosed herein, the product includes at least one source of fat. The particular amount of fat that is present in the liquid nutritional composition may vary depending upon the nutritional needs of the intended user. Fat concentrations usually fall within the range of 1 weight % to 30 weight % (percentages are weight percentages based upon the total weight of the liquid nutritional product), 2 weight % to 15 weight %, or 4 weight % to 10 weight. The amount of fat present can also be characterized as a percentage of total calories in the liquid nutritional product and may vary widely. In certain embodiments, the at least one source of fat comprises 20-85% of the total calories of the liquid nutritional composition and in other embodiments 35-55% of the total calories. In certain embodiments, the liquid nutritional product includes at least one source of fat in an amount sufficient to provide 30-60 grams per liter of total fat.

Various commercial sources of fat exist and may be utilized in the liquid nutritional products disclosed herein. Non-limiting examples of suitable fats or sources thereof for use in the liquid nutritional products disclosed herein include coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils and combination s thereof.

As previously mentioned, in certain embodiments, the liquid nutritional products disclosed herein include at least one source of calcium in an amount sufficient to provide at least 500 mg per liter calcium, preferably 500-2500 mg per liter calcium. In other embodiments, the liquid nutritional products contain less than 500 mg per liter of calcium, such as 10 mg per liter, 50-500 mg per liter or 30-350 mg per liter. Various commercial sources of calcium exist and may be utilized in the liquid nutritional products disclosed herein as long as they are generally compatible with the other ingredients of the liquid nutritional product. Some of the calcium may be provided by calcium HMB. Preferably, the at least one source of calcium includes micro-ionized tricalcium phosphate (wherein the particle size has been reduced to less than about 10 micrometers) which can aid in maintaining the low viscosity of 25-75 cps (25-75 mPa·second) and in obtaining a non-gritty mouthfeel in the product. Other sources of calcium include, but are not limited to, calcium caseinate (in the amounts and under the conditions previously described), calcium citrate, dicalcium phosphate, calcium carbonate, calcium hydroxide and combinations thereof.

In certain embodiments of the liquid nutritional products disclosed herein, the products may contain other ingredients, non-limiting examples of which include preservatives, antioxidants, emulsifying agents, buffers, pharmaceutical actives, additional nutrients, colorants, flavors, thickening agents and stabilizers.

In certain embodiments of the liquid nutritional products disclosed herein, the products may contain vitamins or related nutrients, non-limiting examples of which include vitamin A, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

In certain embodiments of the liquid nutritional products disclosed herein, the products may contain minerals, non-limiting examples of which include phosphorus, magnesium, iron, zinc, manganese, copper, sodium, potassium, molybdenum, chromium, selenium, chloride, and combinations thereof.

The liquid nutritional products may also optionally include one or more masking agents to reduce or otherwise obscure the development of any residual bitter flavors and after taste in the emulsions over time. Suitable masking agents include natural and artificial sweeteners, sodium sources such as sodium chloride, and hydrocolloids, such as guar gum, xanthan gum, carrageenan, gellan gum, and combinations thereof. The amount of masking agent in the nutritional emulsion may vary depending upon the particular masking agent selected, other ingredients in the formulation, and other formulation or product target variables. Such amounts, however, most typically range from at least 0.1%, including from 0.15% to 3.0%, and also including from 0.18% to 2.5%, by weight of the nutritional emulsion.

The liquid nutritional products described herein are useful to provide supplement, primary, or sole sources of nutrition, and or to provide individuals one or more benefits as described herein. In accordance with such methods, the products may be administered orally as needed to provide the desired level of nutrition, most typically in the form of one to two servings daily, in one or two or more divided doses daily, e.g., serving sizes typically ranging from 100 to 300 mL, including from 150 to 250 mL, including from 190 mL to 240 mL.

As previously discussed, the liquid nutritional products disclosed herein have a viscosity of 25-75 cps (25-75 mPa·seconds) and in embodiments containing at least 500 mg per liter calcium a viscosity of 30-75 cps (30-75 mPa·seconds). In certain embodiments, the liquid nutritional products have a viscosity of 25-70 cps (50-65 mPa·seconds), in other embodiments (whether containing at least 500 mg per liter calcium or not) 30-70 cps (30-70 mPa·seconds) and in yet other embodiments 25-65. In still other embodiments, the liquid nutritional products (whether containing at least 500 mg per liter calcium or not) have a viscosity of 30-65 cps (25-65 or 30-65 mPa·seconds). In certain embodiments, the liquid nutritional products include one or more vanilla flavors and have a viscosity of 30-60 cps (30-60 mPa·seconds) or even 30-50 cps (30-50 MPa·seconds). In other embodiments, the liquid nutritional products include one or more chocolate flavors and have a viscosity of 50-75 cps (50-75 mPa·seconds) or even 50-70 cps (50-70 MPa·seconds). The viscosity values provided herein are measured at 25° C., using a Brookfield Model LV Series (Model DV-II) Viscometer, with a #1 spindle installed, operated at 60 rpm (to create a shear rate of about 13 sec⁻¹, utilizing AR&S Method 11.01. The Brookfield Viscometer is a rotational viscometer. It measures the torque required to rotate an immersed spindle (geometry) in a fluid. The spindle is driven by a motor through a calibrated spring; deflection of the spring is indicated by a pointer and dial or a digital display. The viscous drag of the fluid against the spindle is measured by the spring deflection. The measurement range is determined by the rotational speed of the spindle, the size and shape of the spindle, the container the spindle is rotating within and the full scale torque of the calibrated spring. As those skilled in the art will appreciate, while viscosities can be measured under other conditions and according to different methods, modification of one or more test conditions may result in a different viscosity number.

### Methods of Manufacturing

The liquid nutritional compositions that are disclosed herein can be manufactured by any process or suitable method (now known or known in the future) for making nutritional emulsions. In one suitable manufacturing process, at least three separate slurries are prepared. These slurries include: a protein-in-fat (PIF) slurry, a carbohydrate-mineral (CHO-MIN) slurry and a protein-in-water (PIW) slurry. The PIF slurry is formed by heating and mixing any oils that are selected for the fat component (when present) and then adding an emulsifier (e.g., lecithin), fat-soluble vitamins and a portion of the total protein (preferably about half of the milk protein isolate) with continued heat and agitation. The CHO-MN slurry is formed by adding to water (with heat and agitation), minerals (e.g., potassium citrate, dipotassium phosphate, sodium citrate, etc.), trace and ultra trace minerals (often as pre-mix(es)), thickening-type or suspending agents (e.g., Avicel, gellan, carragenan) and any HMB source. The CHO-MIN slurry that results is held for 10 minutes with continued heat and agitation and then additional minerals may be added (e.g., potassium chloride, magnesium carbonate, potassium iodide, etc.) and carbohydrates (e.g., fructooligosaccharides, sucrose, corn syrup, etc.). The PIW slurry is formed by mixing the remaining protein (i.e., sodium caseinate, soy protein, why protein, etc.) into water.

The three slurries are blended together with heat and agitation and the pH is adjusted to the desired range (typically near neutral, around 6.6-7), after which the composition is subjected to high-temperature short-time (HTST) processing during which time the composition is heat treated, emulsified and homogenized and allowed to cool. Water soluble vitamins and ascorbic acid are added (if applicable), the pH is again adjusted (if necessary), flavors are added and any additional water can be added to adjust the solids content to the desired range.

### EXAMPLES

The following examples illustrate specific and exemplary embodiments and features of the liquid nutritional compositions disclosed herein. The examples are provided solely for the purposes of illustration and should not be construed as limitations of the present disclosure. Numerous variations over these specific examples are possible without departing from the spirit and scope of the presently disclosed liquid nutritional compositions. All amounts indicated within the tables below are weight percentages based upon the total weight of the composition, unless indicated otherwise.

### Example 1

A 1000 kg batch of vanilla-flavored liquid nutritional product having a protein content of about 85 grams per liter and a viscosity of 35 cps (35 mPa·seconds) was prepared according to the bill of materials provided in Table 1 below. When preparing the product, the manufacturing method described above (i.e., preparation of PIW, PIF and CHO-MIN slurries) was generally followed with the following changes. The milk protein isolate was split into two roughly equal portions with the first half being added to the PIF blend and the second half being added to the PIW blend. The remaining proteins (i.e., isolated soy protein, whey protein concentrate and sodium caseinate) were added to the PIW blend.

TABLE 1

| Ingredient | Amount (kg) |
|---|---|
| Water | As needed to reach 1000 kg |
| Deionized corn syrup (liquid) | 119.6 |
| Sucrose | 50.2 |
| Partially hydrolyzed sodium caseinate | 36.4 |
| Milk protein isolate | 36.2 |
| Canola oil | 25.7 |
| Isolated soy protein | 14.5 |
| Corn oil | 14.5 |
| Whey protein concentrate (75% protein) | 10.8 |
| Fructo-oligosaccharide (FOS) powder | 7.5 |
| Ca-HMB | 7.1 |
| Potassium citrate | 5.5 |
| Natural and artificial vanilla flavors | 5.0 |
| Lecithin | 1.5 |
| Sodium citrate | 1.4 |
| Micronized tricalcium phosphate | 1.4 |
| Avicel CL-611 | 1.0 |
| Choline chloride | 0.750 |
| Magnesium carbonate | 0.7214 |
| Cream flavor | 0.600 |
| Potassium chloride | 0.5291 |
| UTM/TM Premix¹ | 0.465 |
| Ascorbic acid | 0.284 |
| Water soluble vitamin premix | 0.215 |
| L-carnitine | 0.175 |
| Potassium hydroxide | 0.1096 |
| D,L-alpha tocopheryl acetate | 0.0300 |
| Gellan gum | 0.0250 |
| Beta carotene in oil (30% beta carotene) | 0.0145 |
| Vitamin A palmitate and D3 in oil | 0.0053 |
| Potassium iodide | 0.000240 |
| Phylloquinone | 0.000140 |
| Processing aids (maltodextrin DE18, | As needed to adjust |
| citric acid and 40% potassium hydroxide) | pH and viscosity. |

¹Ultra-trace and trace minerals.

### Example 2

A 1000 kg batch of banana-flavored liquid nutritional product having a protein content of about 85 grams per liter and a viscosity of 35 cps was prepared according to the bill of materials provided in Table 2 below. When preparing the product, the manufacturing method described above (i.e., preparation of PIW, PIF and CHO-MN slurries) was generally followed with the following changes. The milk protein isolate was split into two roughly equal portions with the first half being added to the PIF blend and the second half being added to the PIW blend. The remaining proteins (i.e., isolated soy protein, whey protein concentrate and sodium caseinate) were added to the PIW blend.

TABLE 2

| Ingredient | Amount (kg) |
|---|---|
| Water | As needed to reach 1000 kg |
| Deionized corn syrup (liquid) | 119.6 |
| Sucrose | 50.2 |
| Partially hydrolyzed sodium caseinate | 36.4 |
| Milk protein isolate | 36.2 |
| Canola oil | 25.7 |
| Isolated soy protein | 14.5 |
| Corn oil | 14.5 |
| Whey protein concentrate (75% protein) | 10.8 |
| Fructo-oligosaccharide (FOS) powder | 7.5 |
| Ca-HMB | 7.1 |
| Potassium citrate | 5.5 |
| Lecithin | 1.5 |
| Sodium citrate | 1.4 |
| Micronized tricalcium phosphate | 1.4 |
| Avicel CL-611 | 1.0 |
| Vanilla and banana flavors | 2.0 |
| Choline chloride | 0.750 |
| Magnesium carbonate | 0.7214 |
| Potassium chloride | 0.5291 |
| Cream flavor | 0.500 |
| UTM/TM Premix² | 0.465 |
| Ascorbic acid | 0.284 |
| Water soluble vitamin premix | 0.215 |
| L-carnitine | 0.175 |
| Potassium hydroxide | 0.1096 |
| D,L-alpha tocopheryl acetate | 0.0300 |
| Gellan gum | 0.0250 |
| Beta carotene in oil (30% beta carotene) | 0.0145 |
| Vitamins A palmitate and D3 in oil | 0.0053 |
| Potassium iodide | 0.000240 |
| Phylloquinone | 0.000140 |
| Processing aids (citric acid and 40% | As needed to adjust |
| potassium hydroxide) | pH and viscosity. |

²Ultra-trace and trace minerals

### Example 3

A 1000 kg batch of chocolate-flavored liquid nutritional product having a protein content of about 85 grams per liter and a viscosity of 53 cps (53 mPa·seconds) was prepared according to the bill of materials provided in Table 3 below. When preparing the product, the manufacturing method described above (i.e., preparation of PIW, PIF and CHO-MIN slurries) was generally followed with the following changes. The milk protein isolate was split into two roughly equal portions with the first half being added to the PIF blend and the second half being added to the PIW blend. The remaining proteins (i.e., isolated soy protein, whey protein concentrate and sodium caseinate) were added to the PIW blend.

TABLE 3

| Ingredient | Amount (kg) |
|---|---|
| Water | As needed to reach 1000 kg |
| Deionized corn syrup (liquid) | 120.4 |
| Sucrose | 52.2 |
| Partially hydrolyzed sodium caseinate | 36.5 |
| Milk protein isolate | 35.5 |
| Canola oil | 26.4 |
| Isolated soy protein | 14.7 |
| Corn oil | 14.9 |
| Whey protein concentrate (75% protein) | 10.7 |
| Cocoa powder | 10.1 |
| Fructo-oligosaccharide (FOS) powder | 7.5 |
| Ca-HMB | 7.1 |
| Potassium citrate | 5.2 |
| Lecithin | 1.6 |
| Micronized tricalcium phosphate | 1.5 |
| Cream and vanilla flavors | 3.8 |
| Avicel CL-611 | 1.0 |
| Choline chloride | 0.750 |
| Potassium chloride | 0.710 |
| Magnesium carbonate | 0.540 |
| UTM/TM Premix³ | 0.440 |
| Ascorbic acid | 0.284 |
| Sodium citrate | 0.260 |
| Water soluble vitamin premix | 0.242⁵ |
| L-carnitine | 0.184 |
| Potassium hydroxide | 0.1096 |
| D,L-alpha tocopheryl acetate | 0.0300 |
| Gellan gum | 0.0250 |
| Vitamins A palmitate and D3 in oil (54% | 0.0081 |
| Vitamin A palmitate) | |
| Potassium iodide | 0.000240 |
| Phylloquinone | 0.000135 |
| Processing aids (citric acid and | As needed to adjust |
| 40% potassium hydroxide) | pH and viscosity. |

³Ultra-trace and trace minerals.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A high protein, low viscosity liquid nutritional product comprising:
water;
at least one source of beta-hydroxy-beta-methylbutyrate in an amount sufficient to provide at least 4 g/L beta-hydroxy-beta-methylbutyrate;
80-110 g/L of total protein; and
at least one source of carbohydrate,
wherein said product has a viscosity at 25° C. of 25-75 cps and
30-70 weight % of the total protein is sodium caseinate, at least 30 weight % of the total protein is milk protein isolate, up to 20 weight % of the total protein is sourced from soy, and up to 10 weight % of the total protein is sourced from whey.

2. A liquid nutritional product according to claim 1 wherein the total protein includes at least 5 weight % of whey protein, soy protein or a combination thereof.

3. A liquid nutritional product according to claim 1 further comprising at least one source of fat.

4. A liquid nutritional product according to claim 1 further comprising at least one source of calcium in an amount sufficient to provide at least 500 mg/L calcium.

5. A liquid nutritional product according to claim 4 where the at least one source of calcium comprises micronized tricalcium phosphate.

6. A liquid nutritional product according to claim 1 where the total protein includes up 10 weight % calcium caseinate.

7. A liquid nutritional product according to claim 1 where the at least one source of beta-hydroxy-beta-methylbutyrate comprises calcium beta-hydroxy-beta-methylbutyrate.

8. (canceled)

9. A liquid nutritional product according to claim 1 with a viscosity at 25° C. of 30-65 cps.

10. (canceled)

11. (canceled)

12. A liquid nutritional product according to claim 1 wherein the total protein comprises up to 10 weight % calcium caseinate.

13. A liquid nutritional product according to claim 1 where the sodium caseinate is low viscosity and contains intact protein.

14. A high protein, low viscosity liquid nutritional product comprising:
water;
at least one source of beta-hydroxy-beta-methylbutyrate in an amount sufficient to provide at least 4 g/L beta-hydroxy-beta-methylbutyrate;
80-110 g/L of total protein;
at least one source of carbohydrate;
at least one source of fat;
at least one source of calcium in an amount sufficient to provide at least 500 mg/L calcium,
wherein said liquid has a viscosity at 25 C of 30-75 cps and wherein 30-55 weight % of the total protein is sodium caseinate, at least 35 weight % of the total protein is milk protein isolate, 5-20 weight % of the total protein is soy protein isolate, and 5-10 weight % of the total protein is whey protein.

15. A liquid nutritional product according to claim 14 wherein said at least one source of fat provides 30-60 g/L of fat and said at least one source of carbohydrate provides 100-200 g/L carbohydrate.

16. A liquid nutritional product according to claim 14 where the at least one source of calcium comprises micronized tricalcium phosphate.

17. A liquid nutritional product according to claim 14 where the protein includes up to 10 weight % calcium caseinate.

18. A liquid nutritional product according to claim 14 where the at least one source of beta-hydroxy-beta-methylbutyrate comprises calcium beta-hydroxy-beta-methylbutyrate.

19. (canceled)

20. A liquid nutritional product according to claim 14 with a viscosity at 25° C. of 30-65 cps.

21. A liquid nutritional product according to claim 14 further comprising vanilla flavor and having a viscosity at 25° C. of 25-60 cps.

22. A liquid nutritional product according to claim 14 further comprising chocolate flavor and having a viscosity of 50-75 cps.

23. A liquid nutritional product according to claim 14 where the sodium caseinate is low viscosity and contains intact protein.

24. A liquid nutritional product comprising:
water;
at least one source of beta-hydroxy-beta-methylbutyrate in an amount sufficient to provide at least 4 g/L beta-hydroxy-beta-methylbutyrate where said at least one source of beta-hydroxy-beta-methylbutyrate is selected from the group consisting of sodium HMB, potassium HMB, magnesium HMB, chromium HMB, calcium HMB, alkali metal HMB, alkaline earth metal HMB, HMB lactone and combinations thereof;
80-110 g/L of total protein;
at least one source of carbohydrate;
at least one source of calcium in an amount sufficient to provide at least 500 mg/L calcium,
wherein said emulsion has a viscosity at 25° C. of 30-75 cps and
30-60 weight % of the total protein is low viscosity sodium caseinate, at least 35 weight % of the total protein is milk protein isolate, at least 5 weight % of the total protein is soy protein isolate, whey protein or a combination thereof.

25. (canceled)
